(19) United States
(12) Patent Application Publication
(10) Pub. No.: US 2019/0016577 A1
(43) Pub. Date: Jan. 17, 2019

(54) OPENER FOR EASY-OPEN CANS

(71) Applicant: Shwu-Ruu Chern, Taichung (TW)

(72) Inventor: Shwu-Ruu Chern, Taichung (TW)

(21) Appl. No.: 15/650,895

(22) Filed: Jul. 15, 2017

(51) Int. Cl. B67B 7/40; B67B 7/20; B67B 7/14

(52) U.S. Cl. CPC B67B 7/406; B67B 7/14; B67B 7/20

(57) ABSTRACT

An opener for opening easy-open cans includes a handle having an extension extending from the first end thereof, and a bottle opening portion formed on the second of the handle. The extension has a lug extending from each of two sides thereof. Each lug has a slot defined therethrough. A plate includes a pivotal portion formed on the first end thereof, and an insertion on the second end thereof. The pivotal portion is pivotably connected between the two lugs. The plate has a protrusion extending from each of two sides of the first end thereof so as to be engaged with the slots of the two lugs when the plate is pivoted toward the handle. The insertion is inserted into the gap between the ring and the top of the can to easily pull the ring-pull.

### BACKGROUND OF THE INVENTION

### 1. Fields of the Invention

The present invention relates to an opener, and more particularly, to an opener for opening easy-open cans.

### 2. Descriptions of Related Art

The conventional easy-open cans include a ring-pull pivotably attached to the top of the can by a rivet, and the ring-pull includes a ring formed at the distal end thereof. The users pull the ring-pull upward to detach the distal end of the ring-pull from the top of the can so as to form an opening in the top of the can.

It is noted that the users have to insert one finger into the ring from the gap between the ring-pull and the top of the can so as to pull the ring-pull upward. However, the gap is narrow which is difficult for most of the users to insert one finger into the ring of the ring-pull. For those users who have long nails and kids, the ring-pull is not friendly of use for them.

The present invention intends to provide an opener for opening easy-open cans and the opener eliminates the shortcomings mentioned above.

### SUMMARY OF THE INVENTION

The present invention relates to an opener for opening easy-open cans, and comprises a handle having an extension extending from the first end of the handle. The extension has a lug extending perpendicularly from each of two sides thereof, and each lug has a slot defined therethrough. Each lug further has a notch defined in one end thereof. A plate has a pivotal portion formed on the first end thereof. The pivotal portion is pivotably connected between the two lugs of the extension. The plate has a protrusion extending from each of two sides of the first end thereof. The two protrusions are engaged with the slots of the two lugs when the plate is pivoted toward the handle.

Preferably, the extension extends perpendicularly from the handle.

Preferably, a first bent portion is formed between the handle and the extension.

Preferably, the handle has a bottle opening portion formed on the second end thereof. The bottle opening portion includes a hole, and a tongue extends from the inside of the hole.

Preferably, the plate includes an insertion portion formed on the second end thereof. The insertion portion includes an inclined face defined in one of two sides thereof.

Preferably, the plate includes a second bent portion which forms a recess facing the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the opener for opening easy-open cans of the present invention;

FIG. 2 is an exploded view of the opener for opening easy-open cans of the present invention;

FIG. 3 is a side view of the opener for opening easy-open cans of the present invention;

FIG. 4 is a side cross sectional view of the opener for opening easy-open cans of the present invention;

FIG. 5 shows that the plate is pivoted relative to the handle;

FIG. 6 shows that the protrusions are engaged with the notches of the lugs, and

FIGS. 7 to 11 show the steps that the opener for opening easy-open cans of the present invention opens an easy-open can.

### DETAILED DESCRIPTION OF THE PREFERRED EMBODIMENT

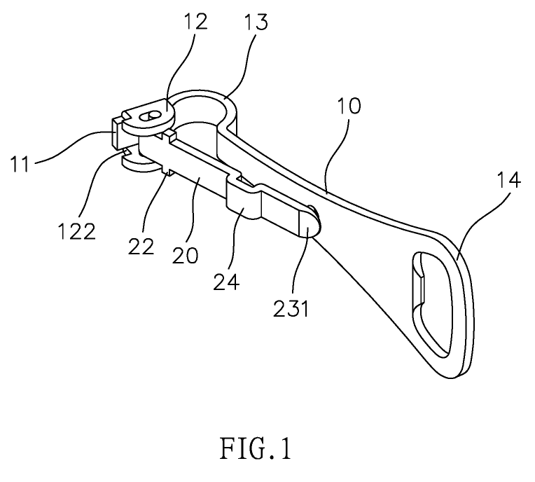

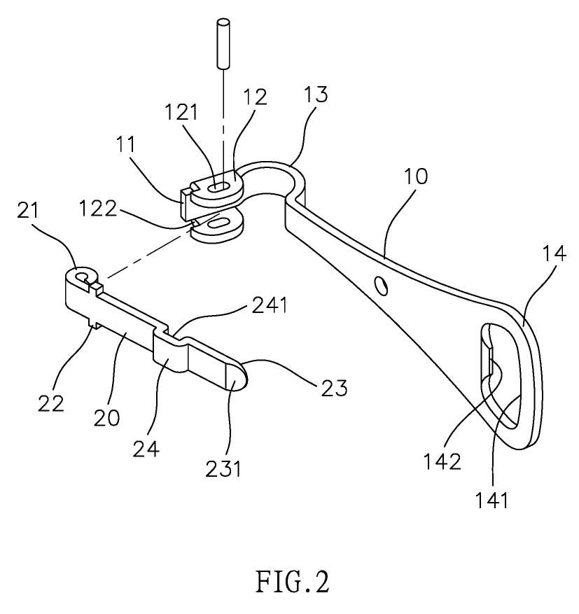

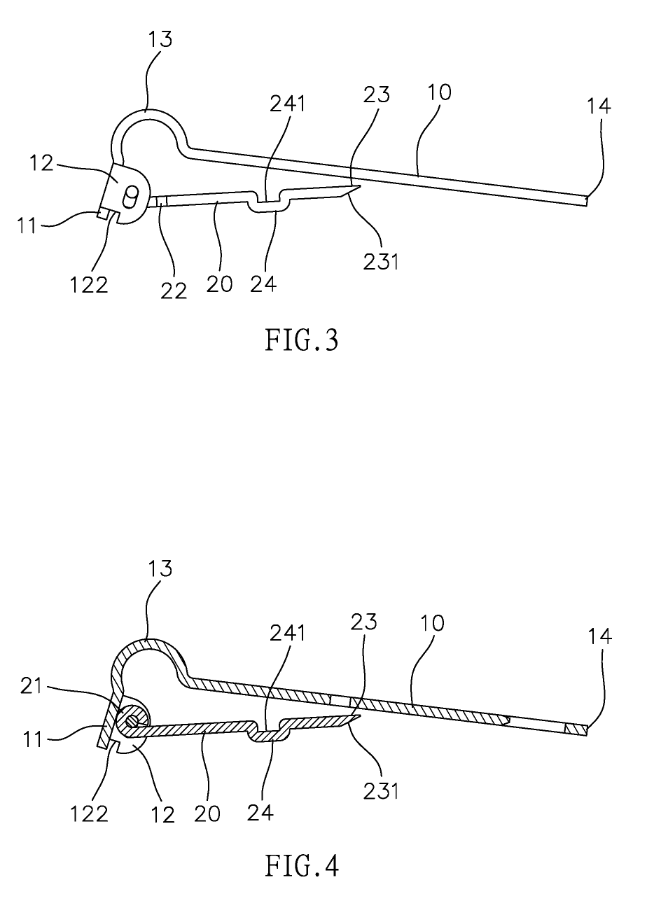

Referring to FIGS. 1 to 11, the opener for opening easy-open cans of the present invention comprises a handle 10 having an extension 11 extending perpendicularly from the first end of the handle 10. A first bent portion 13 is formed between the handle 10 and the extension 11. The extension 11 has a lug 12 extending perpendicularly from each of two sides thereof. Each lug 12 has a slot 121 defined therethrough, and each lug 12 further has a notch 122 defined in one end thereof. A bottle opening portion 14 is formed on the second end of the handle 10. The bottle opening portion 14 includes a hole 141, and a tongue 142 extends from the inside of the hole 141.

A plate 20 has a pivotal portion 21 formed on the first end thereof. The pivotal portion 21 is pivotably connected between the two lugs 12 of the extension 11 by extending a pin through the slots 121 and a passage of the pivotal portion 21. The plate 20 has a protrusion 22 extending from each of two sides of the first end thereof. The plate 20 includes an insertion portion 23 formed on the second end thereof. The insertion portion 23 includes an inclined face 231 defined in one of two sides thereof. The plate 20 further includes a second bent portion 24 which forms a recess 241 facing the handle 10. The recess 241 is located between the pivotal portion 21 and the insertion portion 23.

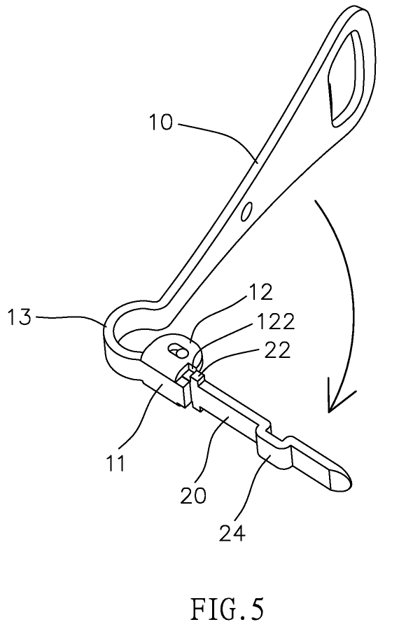

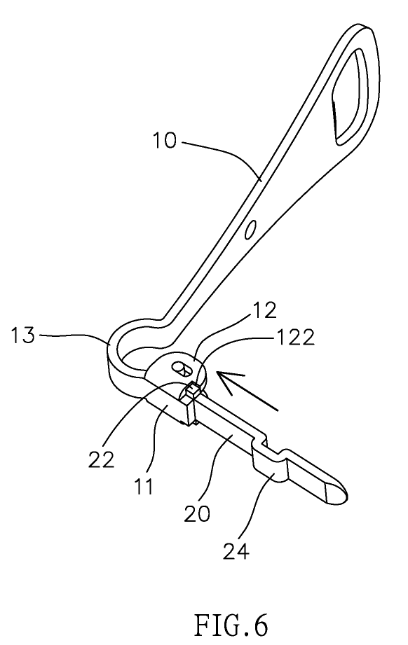

When using the opener to open an easy-open can, the plate 20 is pivoted about the pivotal portion 21 as shown in FIG. 5. The plate 20 is then pushed toward the lugs 12 to engage the protrusions 22 with the notches 122 to position the plate 20 as shown in FIG. 6.

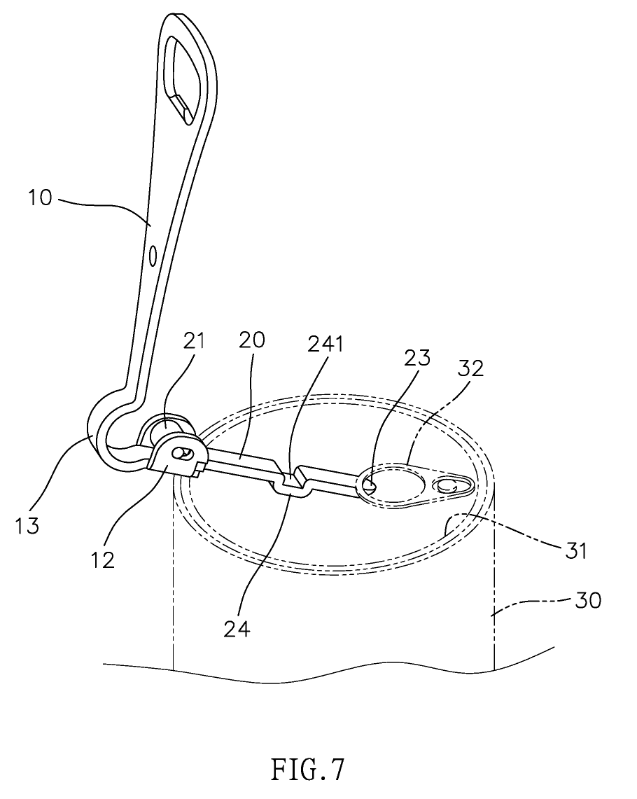

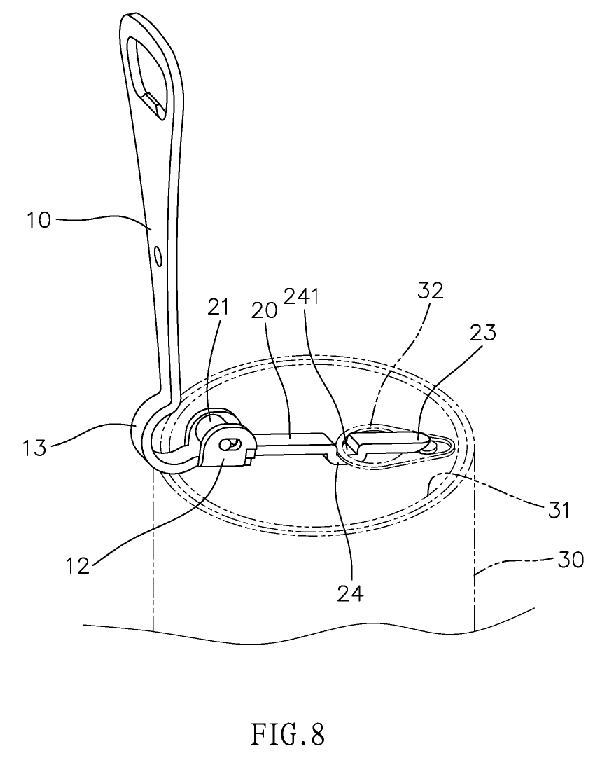

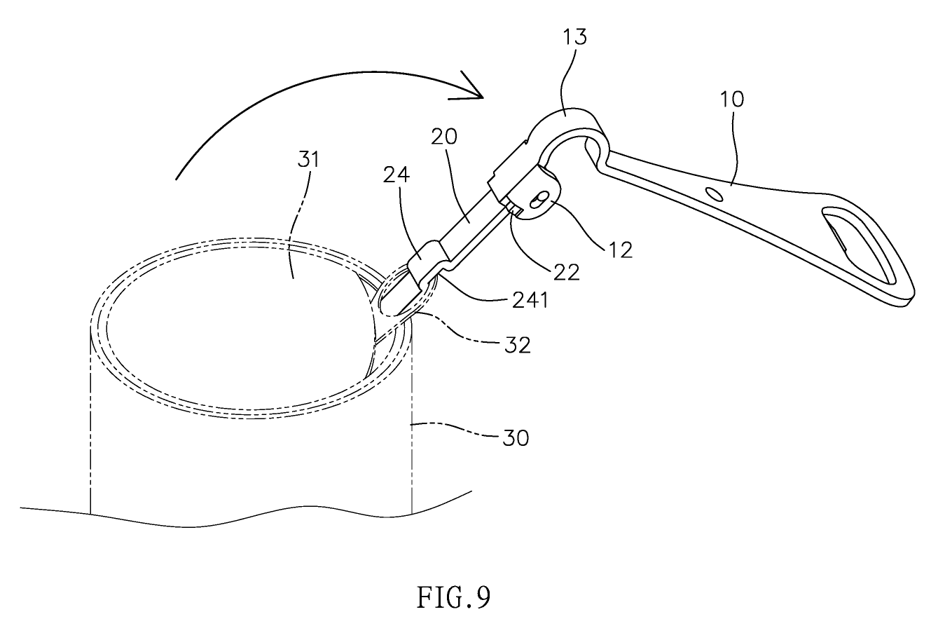

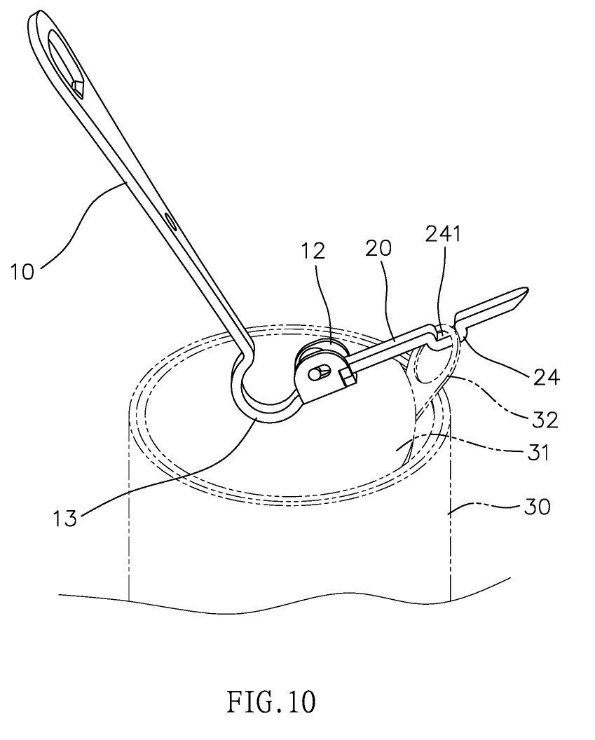

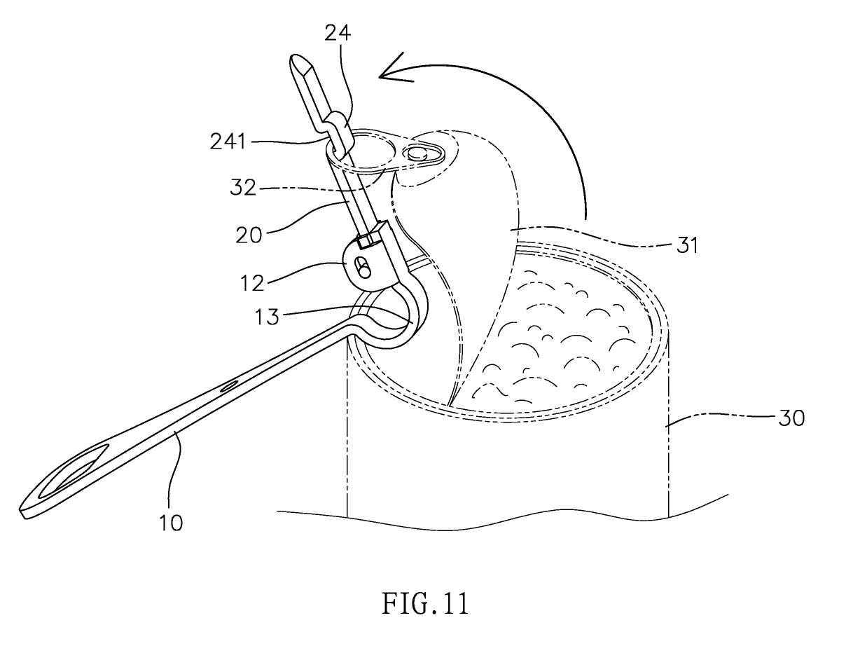

As shown in FIG. 7, the insertion portion 23 is inserted between the ring-pull 31 and the top of the easy-open can 30, and the plate 20 is moved to position the rim of the ring 32 in the recess 241 as shown in FIG. 8. The user then pivots the plate 20 about the insertion portion 23 to pull the ring 32 away from the easy-open can 30 as shown in FIG. 9. As shown in FIG. 10, the user relocates the first bent portion 13 on the top of the easy-open can 30, and pivots the handle 10 about the first bent portion 13 and pivots the handle 10 downward to lift the ring-pull 31 upward as shown in FIG. 11. The top of the easy-open can 30 is successfully opened.

The opener for opening easy-open cans of the present invention is convenient and easily to use for users of different ages.

While we have shown and described the embodiment in accordance with the present invention, it should be clear to those skilled in the art that further embodiments may be made without departing from the scope of the present invention.

What is claimed is:

1. An opener for opening easy-open cans, comprising:
a handle having an extension extending from a first end of the handle, the extension having a lug extending perpendicularly from each of two sides thereof, each lug having a slot defined therethrough, each lug having a notch defined in one end thereof, and
a plate having a pivotal portion formed on a first end thereof, the pivotal portion pivotably connected between the two lugs of the extension, the plate having a protrusion extending from each of two sides of the first end thereof, the two protrusions being engaged with the slots of the two lugs when the plate is pivoted toward the handle.

2. The opener for opening easy-open cans as claimed in claim 1, wherein the extension extends perpendicularly from the handle.

3. The opener for opening easy-open cans as claimed in claim 1, wherein a first bent portion is formed between the handle and the extension.

4. The opener for opening easy-open cans as claimed in claim 1, wherein the handle has a bottle opening portion formed on a second end thereof, the bottle opening portion includes a hole, a tongue extends from an inside of the hole.

5. The opener for opening easy-open cans as claimed in claim 1, wherein the plate includes an insertion portion formed on a second end thereof, the insertion portion includes an inclined face defined in one of two sides thereof.

6. The opener for opening easy-open cans as claimed in claim 1, wherein the plate includes a second bent portion which forms a recess facing the handle.
